(19) United States
(12) Patent Application Publication
(10) Pub. No.: US 2013/0093630 A1
(43) Pub. Date: Apr. 18, 2013

(54) ANTENNA MODULE AND WIRELESS COMMUNICATION DEVICE

(71) Applicants: CHO-KANG HSU, Tu-Cheng (TW); CHIA-HUNG SU, Tu-Cheng (TW); CHIN-HAO CHEN, Tu-Cheng (TW)

(72) Inventors: CHO-KANG HSU, Tu-Cheng (TW); CHIA-HUNG SU, Tu-Cheng (TW); CHIN-HAO CHEN, Tu-Cheng (TW)

(73) Assignee: CHI MEI COMMUNICATION SYSTEMS, INC., Tu-Cheng (TW)

(21) Appl. No.: 13/307,217

(22) Filed: Nov. 30, 2011

(30) Foreign Application Priority Data
Oct. 13, 2011 (TW) 100137200

(51) Int. Cl. H01Q 1/38; H01Q 1/24

(52) U.S. Cl. 343/702; 343/700 MS

(57) ABSTRACT

An antenna module includes a printed circuit board (PCB), a first antenna, a second antenna, a connecting portion, and a feed portion. The first antenna and the second antenna are respectively positioned on two opposite surface of the PCB. The first antenna includes a first radiating body and a first supporting member positioned between the first radiating body and the PCB. A first space is formed between the first radiating body and the PCB. The second antenna includes a second radiating body and a second supporting member positioned between the second radiating body and the PCB. A second space is formed between the second radiating body and the PCB. The connecting portion is connected between the first antenna and the second antenna. The feed portion is positioned on the PCB and is connected to the first and second antennas.

### BACKGROUND

1. Technical Field

The disclosure generally relates to antennas, and particularly to a dual-band antenna used in a wireless communication device.

2. Description of Related Art

A dual-band antenna is commonly a planar antenna, which includes a first radiating portion for transmitting/receiving wireless signals at high frequencies and a second radiating portion for transmitting/receiving wireless signals at low frequencies The first and second radiating portions are usually positioned on a common plane at one side of a wireless communication device. During testing specific absorption rate (SAR) of a wireless communication device using the dual-band antenna, radiation from the first and second radiating portions may be added together, thus SAR at the side of the wireless communication device becomes too high to accord with related SAR rules.

To reduce the SAR, a sensor apparatus is positioned in the wireless communication device, and the wireless communication device reduces an output power of the antenna when the sensor apparatus detects that a user is close to the wireless communication device. However, the communication quality of the wireless communication device may be negatively influenced with the reduced output power, and the sensor apparatus may increase production cost of the wireless communication device.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a schematic view of a wireless communication device, according to an exemplary embodiment of the disclosure.

FIG. 2 is a partial schematic view of the wireless communication device in FIG. 1, according to an exemplary embodiment of the disclosure.

### DETAILED DESCRIPTION

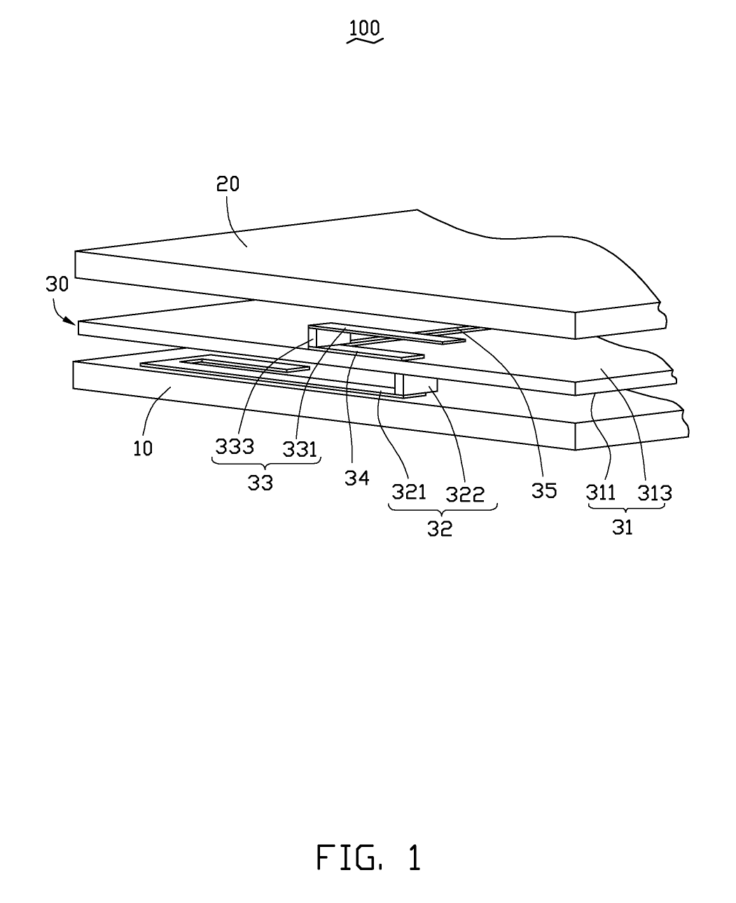

Referring to FIG. 1, an exemplary embodiment of a wireless communication device 100 includes a first housing 10, a second housing 20 and an antenna module 30.

The first housing 10 and the second housing 20 are portions of a shell of the portable electronic device 100. The antenna module 30 is positioned in a receiving space formed between the first housing 10 and the second housing 20.

The antenna module 30 includes a printed circuit board (PCB) 31, a first antenna 32, a second antenna 33, a connecting portion 34 and a feeding portion 35.

The PCB 31 includes a first surface 311 and a second surface 313 opposite to the first surface 311. The first antenna 32 and the second antenna 33 are respectively positioned on the first surface 311 and the second surface 313.

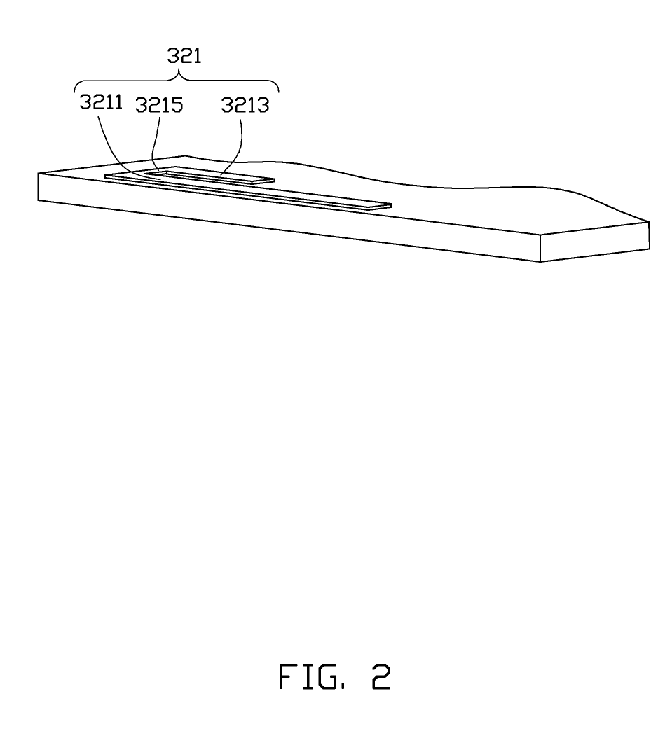

The first antenna 32 transmits/receives wireless signals at low frequencies. The first antenna 32 includes a first radiating body 321 and a supporting member 322. Also referring to FIG. 2, in this embodiment, the first radiating body 321 is substantially U-shaped. The first radiating body 321 includes a first radiating section 3211, a second radiating section 3213 parallel and opposite to the first radiating section 3211, and a third radiating section 3215. The third radiating section 3215 is perpendicularly connected to two ends of the first radiating section 3211 and the second radiating section 3213.

The first supporting member 322 is a sheet made of conductive material such as metal. One end of the first supporting member 322 is perpendicularly positioned on the first surface 311 of the PCB 31. Another end of the first supporting member 322 is perpendicularly connected to an end of the first radiating section 3211 opposite to the third radiating section 3215. A first predetermined space is formed between the first radiating body 321 and the PCB 31. In this embodiment, the first radiating body 321 is attached to an inner surface of the first housing 10 to avoid the first radiating body 321 from moving or swinging relative to the PCB 31 and influence a signal radiating stability of the antenna module 30.

The second antenna 33 transmits/receives wireless signals at high frequencies. The second antenna 33 is substantially similar to the first antenna 31 and includes a second radiating body 331 and a second supporting member 333. The difference between the second radiating body 33 and the first radiating body 31 is that the first radiating body 331 is substantially a rectangular sheet. The second supporting member 333 is substantially similar to the first supporting member 322. One end of the second supporting member 333 is perpendicularly positioned on the second surface 313. Another end of the second supporting member 333 is perpendicularly connected to an end of the second radiating body 331. A second predetermined space is formed between the second radiating body 331 and the PCB 31.

In this embodiment, widths of the first predetermined space and the second predetermined space are about 10 mm-15 mm. The second radiating body 331 may be attached to the second housing 20 to avoid the second radiating body 331 moving or swinging relative to the PCB 31 and influencing a signal radiating stability of the antenna module 30.

The connecting portion 34 is a micro strip positioned on the second surface 313. One end of the connecting portion 34 is connected to the second supporting member 333. Another end of the connecting portion 34 is corresponding to the first supporting member 322, and can be connected to the first supporting member 322 through the PCB 31. The connecting portion 34 matches with the first antenna 32 and the second antenna 33. In other embodiments, the connecting portion 34 may be positioned on the first surface 311.

The feed portion 35 is positioned on the second surface 313 at one side of the connecting portion 34. The feed portion 35 is connected to the second supporting member 333 and connected to the first supporting member 322 through holes (not shown) defined in the PCB 31. The feed portion 35 may be micro strip or coaxial line.

In other embodiment, the structures of the first radiating body 321 and the second radiating body 331 can be changed according to different working frequency requirements. In addition, the first supporting member 322 and the second supporting member 333 may be connected to other portions of the first radiating body 321 and the second radiating body 331 to obtain different signal transmitting paths and corresponding work frequency bands.

The first antenna 32 and the second antenna 33 are respectively positioned at two sides of the PCB 31 with a first space and a second space. Thus, the antenna module 30 has a dispersed and even electromagnetic radiation field and obtains a reduced SAR due to different radiating paths of the first antenna 32 and the second antenna 33. The wireless communication device 100 can have a better communication quality, because the output power of the antenna module 30 does not need to be reduced.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An antenna module comprising:
a printed circuit board (PCB) comprising a first surface and a second surface opposite to the first surface;
a first antenna positioned on the first surface, the first antenna comprising a first radiating body and a first supporting member positioned between the first radiating body and the PCB, a first space formed between the first radiating body and the PCB;
a second antenna positioned on the second surface, the second antenna comprising a second radiating body and a second supporting member positioned between the second radiating body and the PCB, a second space formed between the second radiating body and the PCB;
a connecting portion connected between the first antenna and the second antenna; and
a feed portion positioned on the PCB and connected to the first and second antennas.

2. The antenna module of claim 1, wherein the first supporting member and the second supporting member are metal sheets.

3. The antenna module of claim 1, wherein one end of the first supporting member is positioned on the PCB, another end of the first supporting member is connected to a distal end of the first radiating body; the first radiating body is disposed parallel to the PCB.

4. The antenna module of claim 1, wherein the first radiating body is substantially U-shaped.

5. The antenna module of claim 4, wherein the first radiating body comprises a first radiating section, a second radiating section opposite to the first radiating section and a third radiating section interconnecting the first radiating section and the second radiating section.

6. The antenna module of claim 1, wherein one end of the second supporting member is positioned on the PCB, another end of the second supporting member is connected to a distal end of the second radiating body; the second radiating body is disposed parallel to the PCB.

7. The antenna module of claim 1, wherein the second radiating body is substantially a rectangular sheet.

8. A wireless communication device comprising:
a first housing;
a second housing opposite to the first housing; and
an antenna module positioned in a receiving space formed between the first housing and the second housing, the antenna module comprising:
a printed circuit board (PCB) comprising a first surface and a second surface opposite to the first surface;
a first antenna positioned on the first surface, the first antenna comprising a first radiating body and a first supporting member positioned between the first radiating body and the PCB, a first space formed between the first radiating body and the PCB;
a second antenna positioned on the second surface, the second antenna comprising a second radiating body and a second supporting member positioned between the second radiating body and the PCB, a second space formed between the second radiating body and the PCB;
a connecting portion connected between the first antenna and the second antenna; and
a feed portion positioned on the PCB and connected to the first and second antennas.

9. The wireless communication device of claim 8, wherein the first supporting member and the second supporting member are metal sheets.

10. The wireless communication device of claim 8, wherein one end of the first supporting member is positioned on the PCB, another end of the first supporting member is connected to a distal end of the first radiating body; the first radiating body is positioned parallel to the PCB.

11. The wireless communication device of claim 8, wherein the first radiating body is substantially U-shaped.

12. The wireless communication device of claim 11, wherein the first radiating body comprises a first radiating section, a second radiating section opposite to the first radiating section and a third radiating section interconnecting the first radiating section and the second radiating section.

13. The wireless communication device of claim 8, wherein one end of the second supporting member is positioned on the PCB, another end of the second supporting member is connected to a distal end of the second radiating body; the second radiating body is positioned parallel to the PCB.

14. The wireless communication device of claim 8, wherein the second radiating body is substantially a rectangular sheet.

15. The wireless communication device of claim 8, wherein the first radiating body is attached to the first surface.

16. The wireless communication device of claim 8, wherein the second radiating body is attached to the second surface.
